(19) United States
(12) Patent Application Publication
(10) Pub. No.: US 2024/0295727 A1
(43) Pub. Date: Sep. 5, 2024

(54) ABNORMALITY DETECTION METHOD AND ACTUATOR DEVICE

(71) Applicant: HAMAMATSU PHOTONICS K.K., Hamamatsu-shi (JP)

(72) Inventors: Hidetaka KAWAOKA, Hamamatsu-shi (JP); Tomoyuki IDE, Hamamtsu-shi (JP)

(73) Assignee: HAMAMATSU PHOTONICS K.K., Hamamatsu-shi (JP)

(21) Appl. No.: 18/439,947

(22) Filed: Feb. 13, 2024

(30) Foreign Application Priority Data
Mar. 1, 2023 (JP) 2023-030993

(51) Int. Cl. G02B 26/08; G02B 26/10

(52) U.S. Cl. CPC G02B 26/0816; G02B 26/101

(57) ABSTRACT

An actuator device includes: a first movable portion; a second movable portion; a magnet portion; a coil; and a controller configured to supply a first drive signal for resonantly driving the first movable portion and a second drive signal for non-resonantly driving the second movable portion to the coil. An abnormality detection method includes: supplying the second drive signal to the coil by the controller; acquiring an output value corresponding to a counter electromotive force generated in the coil while the second drive signal is supplied to the coil; and determining whether an abnormality has occurred in a tilted state of the second movable portion on the basis of the second drive signal supplied to the coil and the acquired output value.

### TECHNICAL FIELD

One aspect of the present disclosure relates to an abnormality detection method for an actuator device and an actuator device.

### BACKGROUND

For example, Japanese Unexamined Patent Publication No. 2010-19949 discloses an actuator device including a support portion, a movable portion provided with a coil, a pair of torsion bars swingably connecting the movable portion to the support portion, and a magnet portion applying a magnetic field to the coil. In the actuator device described in Japanese Unexamined Patent Publication No. 2010-19949, breakage of the torsion bar is detected on the basis of an increase or decrease in the resistance value of the coil.

### SUMMARY

### Technical Problem

However, when the magnetic force acting on the coil changes due to, for example, demagnetization of the magnet portion or positional deviation between the magnet portion and the coil, there is a concern that the actuator device may not operate properly even though the resistance value of the coil remains normal.

Here, an object of one aspect of the present disclosure is to provide an abnormality detection method and an actuator device capable of more reliably detecting an abnormality in the actuator device.

### Solution To Problem

An abnormality detection method according to one aspect of the present disclosure is [1] “An abnormality detection method of detecting an abnormality in an actuator device including a support portion, a first movable portion, a second movable portion disposed to surround the first movable portion, a first connection portion connecting the first movable portion to the second movable portion so that the first movable portion is swingable around a first axis, a second connection portion connecting the second movable portion to the support portion so that the second movable portion is swingable around a second axis intersecting the first axis, a detection coil disposed in the second movable portion, a magnet portion generating a magnetic field acting on the detection coil, a drive portion driving the first movable portion and the second movable portion, and a controller configured to supply a first drive signal for resonantly driving the first movable portion and a second drive signal for non-resonantly driving the second movable portion to the drive portion, the abnormality detection method including: a supply step of supplying the second drive signal to the drive portion by the controller; an acquisition step of acquiring an output value corresponding to a counter electromotive force generated in the detection coil while the second drive signal is supplied to the drive portion in the supply step; and a determination step of determining whether an abnormality has occurred in a tilted state of the second movable portion on the basis of the second drive signal supplied to the drive portion in the supply step and the output value acquired in the acquisition step”.

In the abnormality detection method according to [1], an output value corresponding to the counter electromotive force generated in the detection coil is acquired while the second drive signal is supplied to the drive portion in the supply step and it is determined whether an abnormality has occurred in the tilted state of the second movable portion on the basis of the second drive signal supplied to the drive portion in the supply step and the output value acquired in the acquisition step. For example, when the magnetic force applied to the detection coil changes due to demagnetization of the magnet portion or positional deviation between the magnet portion and the detection coil, the counter electromotive force generated in the detection coil also changes. In this abnormality detection method, since an abnormality in the tilted state of the second movable portion is detected using the counter electromotive force generated in the detection coil, it is possible to detect an abnormality in the actuator device caused by various factors such as demagnetization of the magnet portion or positional deviation between the magnet portion and the detection coil in addition to the abnormality in the drive portion (for example, the drive coil or piezoelectric element). Thus, according to this abnormality detection method, it is possible to more reliably detect an abnormality in the actuator device.

The abnormality detection method according to one aspect of the present disclosure may be [2] “The abnormality detection method according to [1], wherein in the supply step, the controller supplies the first drive signal and the second drive signal to the drive portion, and wherein in the acquisition step, the output value is acquired while the first drive signal and the second drive signal are supplied to the drive portion in the supply step”. In this case, it is possible to determine whether an abnormality has occurred in the tilted state of the second movable portion while the first movable portion is resonantly driven.

The abnormality detection method according to one aspect of the present disclosure may be [3] “The abnormality detection method according to [1] or [2], wherein in the determination step, it is determined whether an abnormality has occurred in a tilted state of the second movable portion by determining whether the second movable portion is tilted”. In this case, it is possible to detect an abnormality in which the second movable portion, which should be tilted, is not tilted.

The abnormality detection method according to one aspect of the present disclosure may be [4] “The abnormality detection method according to any one of [1] to [3], wherein the drive portion includes a drive coil for driving at least one of the first movable portion and the second movable portion, and wherein the detection coil is composed of the drive coil”. In this case, the space for arranging the coil in the second movable portion can be reduced compared to a case in which the detection coil is provided separately from the drive coil.

The abnormality detection method according to one aspect of the present disclosure may be [5] “The abnormality detection method according to any one of [1] to [4], wherein the drive portion includes a first drive coil for driving the first movable portion and a second drive coil for driving the second movable portion, and wherein the first drive coil and the second drive coil are arranged in the second movable portion”. In this case, the weight of the first movable portion driven resonantly can be reduced and the power for driving the first movable portion can be reduced compared to a case in which the first drive coil is disposed in the first movable portion. Further, the inertia moment of the first movable portion around the first axis can be reduced and a decrease in the resonance frequency can be suppressed.

The abnormality detection method according to one aspect of the present disclosure may be [6] “The abnormality detection method according to [5], wherein the detection coil is composed of the first drive coil and the second drive coil, wherein in the acquisition step, a first output value corresponding to a counter electromotive force generated in the first drive coil and a second output value corresponding to a counter electromotive force generated in the second drive coil are acquired while the second drive signal is supplied to the drive portion, and wherein in the determination step, it is determined whether an abnormality has occurred in a tilted state of the second movable portion on the basis of the second drive signal supplied to the drive portion in the supply step and the first output value and the second output value acquired in the acquisition step”. In this case, it is possible to more reliably determine whether an abnormality has occurred in the tilted state of the second movable portion.

The abnormality detection method according to one aspect of the present disclosure may be [7] “The abnormality detection method according to [5], wherein the number of turns of one of the first drive coil and the second drive coil is larger than the number of turns of the other of the first drive coil and the second drive coil, and wherein the detection coil is composed of the one of the first drive coil and the second drive coil”. In this case, since the detection coil is composed of the coil with a larger number of turns in the first drive coil and the second drive coil, it is possible to increase the counter electromotive force generated in the detection coil compared to, for example, a case in which the detection coil is composed of the coil with a smaller number of turns in the first drive coil and the second drive coil. When a large counter electromotive force can be acquired, the gain for amplifying the counter electromotive force to a certain value can be reduced, and the noise superimposed on the output value corresponding to the counter electromotive force can be reduced. Further, it is possible to suppress an increase in the size of the second movable portion compared to, for example, a case in which the number of turns of both the first drive coil and the second drive coil is large.

The abnormality detection method according to one aspect of the present disclosure may be [8] “The abnormality detection method according to any one of [1] to [7], wherein the drive portion includes a first drive portion for driving the first movable portion and a second drive portion for driving the second movable portion, wherein the first drive portion is disposed in the second movable portion, and wherein the second drive portion is disposed in the second movable portion or the second connection portion”. In this case, since the first drive portion is disposed in the second movable portion, when the first drive signal is supplied to the first drive portion to resonantly drive the first movable portion, the second movable portion also vibrates at a frequency corresponding to the resonance frequency of the first movable portion. Therefore, the counter electromotive force generated in the detection coil disposed in the second movable portion reflects the tilted state of the first movable portion. That is, in this case, the output value of the counter electromotive force that reflects the tilted state of the first movable portion can be acquired in the acquisition step. Further, the weight of the first movable portion can be reduced and the inertia moment of the first movable portion can be reduced compared to a case in which the first drive portion is disposed in the first movable portion.

The abnormality detection method according to one aspect of the present disclosure may be [9] “The abnormality detection method according to any one of [1] to [4], wherein the drive portion includes a single drive coil for driving both the first movable portion and the second movable portion, wherein the single drive coil is disposed in the second movable portion, and wherein the detection coil is composed of the single drive coil”. In this case, the number of turns of the drive coil (single drive coil) for driving the first movable portion and the second movable portion can be increased compared to a case in which the drive coil for driving the first movable portion and the drive coil for driving the second movable portion are provided separately. Then, since the detection coil is composed of a single drive coil with a large number of turns, the signal amount of the counter electromotive force generated in the detection coil can be increased.

The abnormality detection method according to one aspect of the present disclosure may be [10] “The abnormality detection method according to any one of [1] to [9], wherein in the supply step, the controller supplies a signal for continuously swinging the second movable portion at a predetermined deflection angle to the drive portion as the second drive signal”. In this case, it is possible to determine whether an abnormality has occurred in the tilted state of the second movable portion when the second movable portion is continuously swung at a predetermined deflection angle.

The abnormality detection method according to one aspect of the present disclosure may be [11] “The abnormality detection method according to any one of [1] to [10], wherein in the supply step, the controller supplies a signal for stopping the second movable portion at a predetermined angle to the drive portion as the second drive signal”. In this case, it is possible to determine whether an abnormality has occurred in the tilted state of the second movable portion when the second movable portion is stopped at a predetermined angle.

The abnormality detection method according to one aspect of the present disclosure may be [12] “The abnormality detection method according to any one of [1] to [11], wherein the actuator device further includes an amplification circuit, and wherein in the acquisition step, the counter electromotive force amplified 10 times or more by the amplification circuit is acquired as the output value”. In this case, it is possible to satisfactorily determine whether an abnormality has occurred in the tilted state of the second movable portion even when the change in the counter electromotive force generated in the detection coil is small.

The abnormality detection method according to one aspect of the present disclosure may be [13] “The abnormality detection method according to any one of [1] to [12], wherein the actuator device further includes an optical function part which is formed in the first movable portion and onto which light is incident from a light source”. In this case, it is possible to more reliably detect an abnormality in the actuator device including the optical function part onto which light is incident from the light source.

The abnormality detection method according to one aspect of the present disclosure may be [14] “The abnormality detection method according to [13], further including: a stop step of stopping irradiating the optical function part with light from the light source when it is determined that an abnormality has occurred in a tilted state of the second movable portion in the determination step”. In this case, since the irradiation of light to the optical function part is stopped when it is determined that an abnormality has occurred in the tilted state of the second movable portion, it is possible to prevent, for example, a situation in which the light reflected by the optical function part continuously irradiates an object to thereby damage the object.

An actuator device according to one aspect of the present disclosure is [15] “An actuator device including: a support portion; a first movable portion; a second movable portion disposed to surround the first movable portion; a first connection portion connecting the first movable portion to the second movable portion so that the first movable portion is swingable around a first axis; a second connection portion connecting the second movable portion to the support portion so that the second movable portion is swingable around a second axis intersecting the first axis; a detection coil disposed in the second movable portion; a magnet portion generating a magnetic field acting on the detection coil; a drive portion driving the first movable portion and the second movable portion; a controller configured to supply a first drive signal for resonantly driving the first movable portion and a second drive signal for non-resonantly driving the second movable portion to the drive portion; an acquisition unit acquiring an output value corresponding to a counter electromotive force generated in the detection coil while the second drive signal is supplied from the controller to the drive portion; and a determination unit determining whether an abnormality has occurred in a tilted state of the second movable portion on the basis of the second drive signal supplied to the drive portion during acquisition of the output value by the acquisition unit and the output value acquired by the acquisition unit”. According to this actuator device, it is possible to more reliably detect an abnormality in the actuator device for the above-described reasons.

According to one aspect of the present disclosure, it is possible to provide an abnormality detection method and an actuator device capable of more reliably detecting an abnormality in the actuator device.

### BRIEF DESCRIPTION OF THE DRAWINGS

FIG. 1 is a plan view of an actuator device according to an embodiment;

FIG. 2 is a flowchart showing an abnormality detection method for an actuator device according to an embodiment;

FIG. 3 is a graph showing a counter electromotive force caused by the driving of a first movable portion that is driven resonantly;

FIG. 4 is a graph showing a counter electromotive force caused by the driving of a second movable portion that is driven non-resonantly; and

FIG. 5 is a cross-sectional view of an actuator device of modified example.

### DETAILED DESCRIPTION

Hereinafter, embodiments of the present disclosure will be described in detail with reference to the drawings. In the following description, the same reference numerals will be used for the same or equivalent elements, and overlapping description will be omitted.

### Configuration of Actuator Device

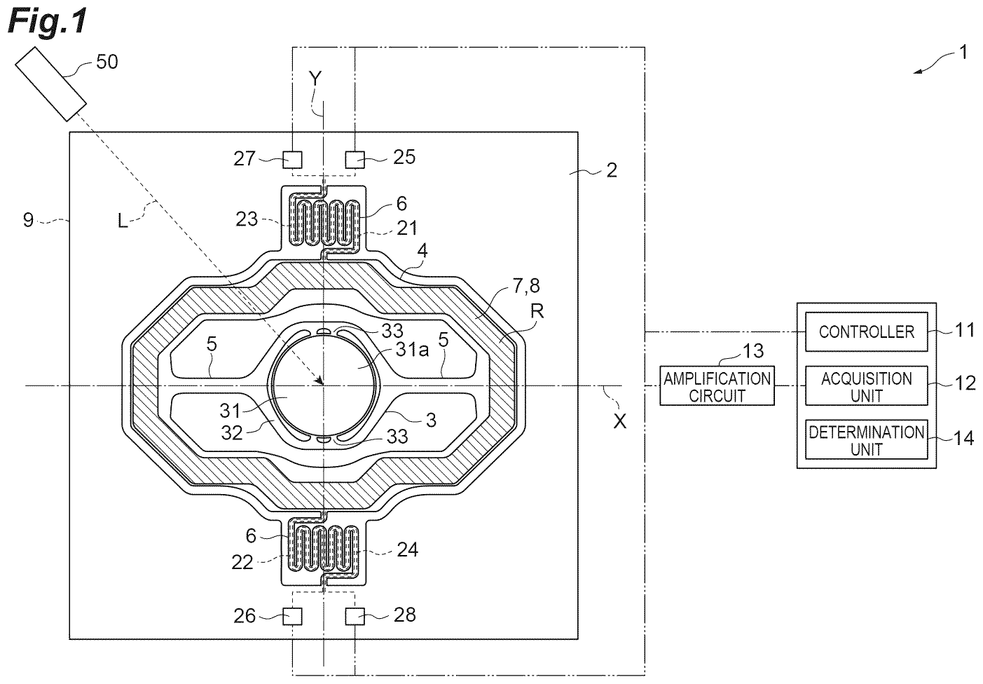

As shown in FIG. 1, an actuator device 1 includes a support portion 2, a first movable portion 3, a second movable portion 4, a pair of first torsion bars (first connection portions) 5, a pair of second torsion bars (second connection portions) 6, coils 7 and 8, and a magnet portion 9. In the actuator device 1, the first movable portion 3 having a mirror surface (optical function part) 31a swings around each of an X axis (first axis) and a Y axis (second axis intersecting the first axis) which are orthogonal to each other. The actuator device 1 can be used, for example, as such as an optical scanner or an optical switch for optical communication.

The support portion 2, the first movable portion 3, the second movable portion 4, the pair of first torsion bars 5, and the pair of second torsion bars 6 are integrally formed by, for example, an SOI (Silicon on Insulator) substrate. That is, the actuator device 1 is configured as a MEMS device manufactured by processing a semiconductor substrate using a MEMS technology (patterning, etching, etc.). The SOI substrate includes a pair of semiconductor layers and an insulating layer disposed between the pair of semiconductor layers. For example, each semiconductor layer is made of silicon, and the insulating layer is made of silicon dioxide. The support portion 2 is formed in a frame shape with a rectangular outer shape, and supports the first movable portion 3, the second movable portion 4, and the like.

The first movable portion 3 is disposed inside the support portion 2. The first movable portion 3 includes a main body portion 31, an annular portion 32, and a pair of connection portions 33. The main body portion 31 is formed in a circular shape. The circular mirror surface (optical function part) 31a is formed on the surface of the main body portion 31. The mirror surface 31a is a metal film made of, for example, aluminum. The annular portion 32 is formed in an annular shape to surround the main body portion 31. The pair of connection portions 33 are arranged on both sides of the main body portion 31 on the Y axis, and connect the main body portion 31 and the annular portion 32. Unlike the first torsion bar 5 and the second torsion bar 6, the pair of connection portions 33 do not connect the main body portion 31 to the annular portion 32 in a swingable manner (they are not torsion bars). The second movable portion 4 is formed in a frame shape and is disposed inside the support portion 2 to surround the first movable portion 3.

The pair of first torsion bars 5 are arranged on both sides of the first movable portion 3 on the X axis. The first torsion bar 5 connects the first movable portion 3 (annular portion 32) to the second movable portion 4 on the X axis so that the first movable portion 3 is swingable around the X axis (with the X axis as the center line). The first torsion bar 5 is connected to the support portion 2 via the second movable portion 4 and the second torsion bar 6 which will be described later. That is, the first torsion bar 5 can also be considered to connect the first movable portion 3 to the support portion 2 so that the first movable portion 3 is swingable around the X axis. Each first torsion bar 5 is torsionally deformed when the first movable portion 3 swings around the X axis. Each first torsion bar 5 extends straight on the X axis.

The pair of second torsion bars 6 are arranged on both sides of the second movable portion 4 on the Y axis. The second torsion bar 6 connects the second movable portion 4 to the support portion 2 on the Y axis so that the second movable portion 4 is swingable around the Y axis (with the Y axis as the center line). Each second torsion bar 6 is torsionally deformed when the second movable portion 4 swings around the Y axis. Each second torsion bar 6 extends in a meandering manner.

Each of the coils 7 and 8 is disposed in the second movable portion 4 to surround the first movable portion 3, and extends in a spiral shape when viewed from above. In FIG. 1, an arrangement region R in which the coils 7 and 8 are arranged is shown by hatching. The coils 7 and 8 are arranged along a plane including the X axis and the Y axis. Each of the coils 7 and 8 is wound around the first movable portion 3 a plurality of times. In this example, the number of turns of coil 7 is larger than the number of turns of coil 8. The coils 7 and 8 are arranged alternately in the width direction of the second movable portion 4, for example, in a plan view. Each of the coils 7 and 8 is made of a metal material such as copper or gold.

The coils 7 and 8 are drive portions that drive the first movable portion 3 and the second movable portion 4. More specifically, the coil 7 is a first drive coil (first drive portion) for driving the first movable portion 3, and the coil 8 is a second drive coil (second drive portion) for driving the second movable portion 4. The coil 7 drives the first movable portion 3 by being supplied with a drive signal (drive current) from a controller 11 which will be described later. Similarly, the coil 8 drives the second movable portion 4 by being supplied with a drive signal from the controller 11. The driving of the first movable portion 3 and the second movable portion 4 by the coils 7 and 8 will be described later.

The actuator device 1 further includes a plurality of wirings 21, 22, 23, and 24 and a plurality of external terminals 25, 26, 27, and 28. The external terminals 25 to 28 are electrode pads provided on the support portion 2, and are electrically connected to the controller 11 and the like which will be described later. The wiring 21 is electrically connected to the inner end of the coil 7 and the external terminal 25. The wiring 21 extends from the inner end of the coil 7 to the external terminal 25 via the corresponding second torsion bar 6. The wiring 22 is electrically connected to the outer end of the coil 7 and the external terminal 26. The wiring 22 extends from the outer end of the coil 7 to the external terminal 26 via the corresponding second torsion bar 6.

The wiring 23 is electrically connected to the inner end of the coil 8 and the external terminal 27. The wiring 23 extends from the inner end of the coil 8 to the external terminal 27 via the corresponding second torsion bar 6. The wiring 24 is electrically connected to the outer end of the coil 8 and the external terminal 28. The wiring 24 extends from the outer end of the coil 8 to the external terminal 28 via the corresponding second torsion bar 6. Each of the wirings 21 to 24 is made of a metal material such as aluminum.

The magnet portion 9 is composed of, for example, a plurality of permanent magnets arranged in a Halbach array. The magnet portion 9 generates a magnetic field that acts on the coils 7 and 8. The magnet portion 9 is disposed on one side (the opposite side to the mirror surface 31a) in a direction perpendicular to the X axis and the Y axis with respect to the support portion 2, the first movable portion 3, the second movable portion 4, and the like.

The actuator device 1 further includes the controller 11, an acquisition unit 12, an amplification circuit 13, and a determination unit 14. The controller 11, the acquisition unit 12, and the determination unit 14 are configured by, for example, a computer device including a processor, a memory, and the like. The controller 11 supplies the coils 7 and 8 with drive signals for driving the first movable portion 3 and the second movable portion 4. More specifically, the controller 11 supplies a first drive signal to the coil 7 via external terminals 25 and 26 and wirings 21 and 22, and supplies a second drive signal to the coil 8 via external terminals 27 and 28 and wirings 23 and 24. The controller 11 may supply a drive signal (drive current) from a power source (not shown) to the coils 7 and 8 by controlling the power source (not shown) using a processor. At least one of the controller 11, the acquisition unit 12, and the determination unit 14 may be configured by an electronic element on a circuit board. For example, the controller 11 and the determination unit 14 may be configured by a computer device, and the acquisition unit 12 may be configured by a memory on a circuit board. Alternatively, the controller 11, the acquisition unit 12, and the determination unit 14 may be configured by electronic elements on a circuit board.

The first drive signal is an electric signal (drive current) for resonantly driving (non-linearly operating) the first movable portion 3 with the X axis as the center line. The resonant driving is driving that utilizes the resonance of the object to be driven (in this example, the first movable portion 3). When the first drive signal is supplied to the coil 7, a Lorentz force acts on the coil 7 due to interaction with the magnetic field generated by the magnet portion 9. In addition to this Lorentz force, the first movable portion 3 can be driven resonantly with the X axis as the center line by utilizing the resonance of the first movable portion 3 at the resonance frequency. More specifically, when the controller 11 supplies the coil 7 with a drive current (first drive signal) having a frequency equal to the resonance frequency of the first movable portion 3 around the X axis, the second movable portion 4 vibrates slightly around the X axis at the frequency along with the coil 7. By transmitting this vibration to the first movable portion 3 via the pair of first torsion bars 5, the first movable portion 3 can be driven resonantly at the frequency with the X axis as the center line. The resonance frequency of the first movable portion 3 is determined by, for example, the mass and structure of the first movable portion 3, the spring constant of the pair of first torsion bars 5, and the like.

The second drive signal is an electric signal (drive current) for non-resonantly driving (linearly operating) the second movable portion 4 with the Y axis as the center line. Unlike the resonant driving, non-resonant driving is driving that does not utilize the resonance of the object to be driven (in this example, the second movable portion 4). When a drive current (second drive signal) is supplied to the coil 8, a Lorentz force acts on the coil 8 due to interaction with the magnetic field generated by the magnet portion 9. By utilizing the balance between this Lorentz force and the elastic force of the pair of second torsion bars 6, the second movable portion 4 can be driven non-resonantly with the Y axis as the center line. The resonant driving which uses resonance to swing an object is swingable the object faster than non-resonant driving, which does not use resonance to swing the object. For example, the drive frequency of the resonant driving is about several kHz to several tens of kHz, and the drive frequency of the non-resonant driving is about several tens of Hz. That is, in this embodiment, the X axis constitutes a high-speed axis around which the first movable portion 3 swings at high speed, and the Y axis constitutes a low-speed axis around which the second movable portion 4 swings at low speed compared to the first movable portion 3. When the first movable portion 3 and the second movable portion 4 swing, the mirror surface 31a formed on the first movable portion 3 also swings.

When the second movable portion 4 swings, the coils 7 and 8 arranged in the second movable portion 4 move within the magnetic field generated by the magnet portion 9. At this time, a counter electromotive force is generated in the coils 7 and 8 according to the magnetic field. An output value corresponding to the counter electromotive force generated in the coils 7 and 8 is acquired by the acquisition unit 12 which will be described later, and is used to detect an abnormality in the actuator device 1. That is, the coils 7 and 8 constitute a detection coil for detecting a counter electromotive force used for detecting an abnormality in the actuator device 1. The counter electromotive force generated in the coils 7 and 8 is determined by the speed at which the coils 7 and 8 pass through the magnetic field, the strength of the magnetic field, the shape of the coils, and the like.

The acquisition unit 12 acquires an output value corresponding to a counter electromotive force generated in the coil 7 and the coil 8. More specifically, the acquisition unit 12 acquires an output value corresponding to the counter electromotive force generated in the coils 7 and 8 while the first drive signal and the second drive signal are supplied from the controller 11 to the coils 7 and 8. The acquisition unit 12 is electrically connected to the coils 7 and 8 via the amplification circuit 13 which will be described later. In this embodiment, the acquisition unit 12 acquires the counter electromotive force amplified by the amplification circuit 13 as an output value corresponding to the counter electromotive force.

The amplification circuit 13 amplifies the counter electromotive force generated in the coils 7 and 8, and outputs the amplified counter electromotive force to the acquisition unit 12. The amplification circuit 13 is electrically connected to the coil 7 via the external terminals 25 and 26 and the wirings 21 and 22, and electrically connected to the coil 8 via the external terminals 27 and 28 and the wirings 23 and 24. The amplification circuit 13 may amplify the counter electromotive force generated in the coils 7 and 8 by, for example, 10 times or more or 30 times or more.

The determination unit 14 determines whether an abnormality has occurred in the operation of the second movable portion 4. More specifically, the determination unit 14 determines whether an abnormality has occurred in the tilted state of the second movable portion 4. The determination unit 14 determines whether an abnormality has occurred in the tilted state of the second movable portion 4 on the basis of the second drive signal supplied from the controller 11 to the coil 8 during the acquisition of the output value corresponding to the counter electromotive force by the acquisition unit 12 and the output value corresponding to the counter electromotive force acquired by the acquisition unit 12.

As described above, the counter electromotive force generated in the coils 7 and 8 is determined by the speed at which the coils pass through the magnetic field, the strength of the magnetic field, the shape of the coils, and the like. For example, when an abnormality has occurred in the tilted state of the second movable portion 4, the speed at which the coils 7 and 8 arranged in the second movable portion 4 pass through the magnetic field is changed from the speed when no abnormality occurs. That is, the counter electromotive force generated in the coils 7 and 8 when an abnormality has occurred in the tilted state of the second movable portion 4 is changed from the counter electromotive force generated in the coils 7 and 8 when no abnormality has occurred. The determination unit 14 determines whether an abnormality has occurred in the tilted state of the second movable portion 4 by monitoring changes in this counter electromotive force. Details of the determination process by the determination unit 14 will be described later.

The actuator device 1 further includes a light source 50. The light source 50 irradiates the mirror surface 31a with light L. The light L reflected on the mirror surface 31a is scanned with respect to the object to which the light L is irradiated by the swinging of the mirror surface 31a. The light L emitted from the light source 50 may be, for example, laser light or light from an LED (Light Emitting Diode).

### Actuator Device Abnormality Detection Method

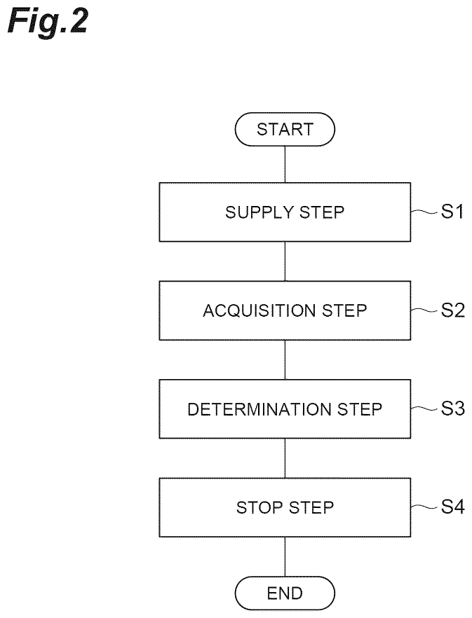

Referring to FIG. 2, a method for detecting an abnormality in the actuator device 1 will be described. In this abnormality detection method, an abnormality in the actuator device 1 is detected by determining whether an abnormality has occurred in the tilted state of the second movable portion 4.

First, the actuator device 1 is prepared (preparation step). Subsequently, the controller 11 supplies drive signals to the coils 7 and 8 (supply step S1). Specifically, the controller 11 supplies a first drive signal for resonantly driving the first movable portion 3 to the coil 7 and also supplies a second drive signal for non-resonantly driving the second movable portion 4 to the coil 8. As an example, the first drive signal is a drive current for resonantly driving the first movable portion 3 at a target deflection angle (20° in this example), and the second drive signal is a drive current for non-resonantly driving (continuously swinging) the second movable portion 4 at a target deflection angle (10° in this example). The deflection angle means an optical deflection angle. The optical deflection angle is the angle formed by the incident light and the reflected light on the mirror surface 31a, and is twice the mechanical deflection angle which is the angle at which the mirror is tilted. In addition, the deflection angle is on the basis (the deflection angle is 0°) of a state in which no drive signal is supplied to the coils 7 and 8 (in this example, a state in which the mirror surface 31a is parallel to the X axis and the Y axis).

As the supply step S1 is performed, the light source 50 irradiates the mirror surface 31a with the light L. The light L is reflected by the mirror surface 31a and is irradiated onto the object. The timing at which the light source 50 starts irradiating the light L is any timing, and may be before the supply step S1 is started or after a predetermined time has elapsed after the start of the supply step S1.

Subsequently, the acquisition unit 12 acquires an output value corresponding to the counter electromotive force generated in the coils 7 and 8 (acquisition step S2). Specifically, the acquisition unit 12 acquires a first output value corresponding to the counter electromotive force generated in the coil 7 and a second output value corresponding to the counter electromotive force generated in the coil 8 while the first drive signal and the second drive signal are supplied in the supply step S1. The coils 7 and 8 are arranged in the second movable portion 4.

Therefore, the counter electromotive force generated in each of the coils 7 and 8 reflects the tilted state of the second movable portion 4. Further, in this embodiment, when the first drive signal is supplied to the coil 7 to resonantly drive the first movable portion 3, the second movable portion 4 also vibrates at a frequency corresponding to the resonance frequency of the first movable portion 3. Therefore, the counter electromotive force generated in each of the coils 7 and 8 arranged in the second movable portion 4 also reflects the tilted state of the first movable portion 3. That is, the counter electromotive force generated in each of the coils 7 and 8 reflects the tilted state of both the first movable portion 3 and the second movable portion 4. The amplification circuit 13 amplifies the counter electromotive force generated in the coils 7 and 8. In this example, the amplification circuit 13 amplifies the counter electromotive force 10 times or more. The acquisition unit 12 acquires the amplified value of the counter electromotive force generated in the coil 7 as a first output value, and acquires the amplified value of the counter electromotive force generated in the coil 8 as a second output value.

Subsequently, the determination unit 14 determines whether an abnormality has occurred in the tilted state of the second movable portion 4 (determination step S3). The determination unit 14 determines whether an abnormality has occurred in the tilted state of the second movable portion 4 on the basis of the second drive signal supplied to the coil 8 in the supply step S1 and the first output value and second output value acquired in the acquisition step S2. In this example, the determination unit 14 determines whether an abnormality has occurred in the tilted state of the second movable portion 4 by determining whether the second movable portion 4 is tilted (whether the deflection angle of the second movable portion 4 is 0°).

As described above, the counter electromotive force generated in each of the coils 7 and 8 arranged in the second movable portion 4 reflects the tilted state of the first movable portion 3 and the second movable portion 4. Therefore, the first output value and the second output value acquired when an abnormality has occurred in the tilted state of the second movable portion 4 change from the output value (normal output value) acquired when the tilted state of the second movable portion 4 is normal. More specifically, when a case in which the second movable portion 4 is not tilted is defined as a case in which an abnormality has occurred in the tilted state of the second movable portion 4, the first output value and second output value acquired when the second movable portion 4 is not tilted change from the first output value and second output value acquired when the second movable portion 4 is tilted. The determination unit 14 determines whether the second movable portion 4 is tilted by monitoring changes in the first output value and the second output value, and determines that an abnormality has occurred in the tilted state of the second movable portion 4 when determining that the second movable portion 4 is not tilted.

A counter electromotive force caused by the driving of the first movable portion 3 and a counter electromotive force caused by the driving of the second movable portion 4 are respectively generated in the coils 7 and 8. Since the moving speed of the first movable portion 3 that is driven resonantly is fast, the counter electromotive force caused by the driving of the first movable portion 3 is relatively large. On the other hand, since the moving speed of the second movable portion 4 that is driven non-resonantly is slower than that of the first movable portion 3, the counter electromotive force caused by the driving of the second movable portion 4 is relatively small.

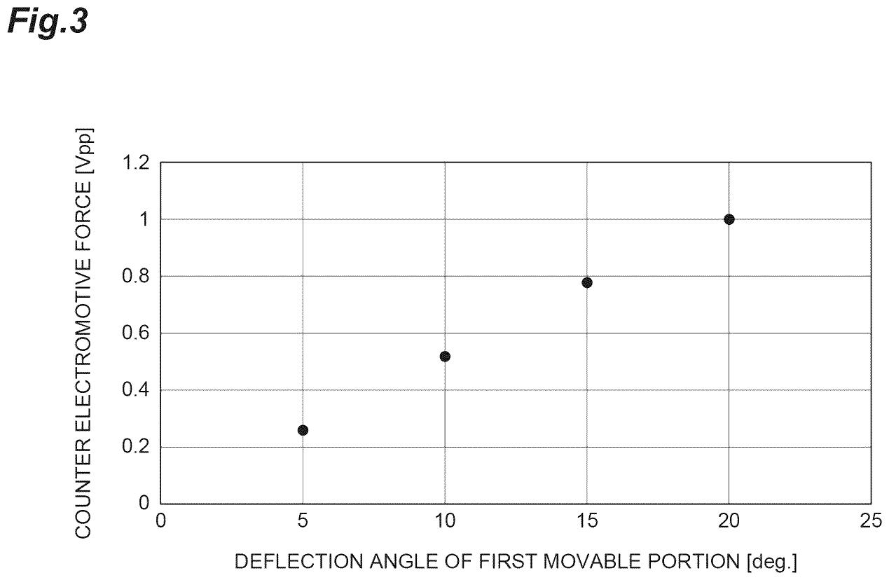

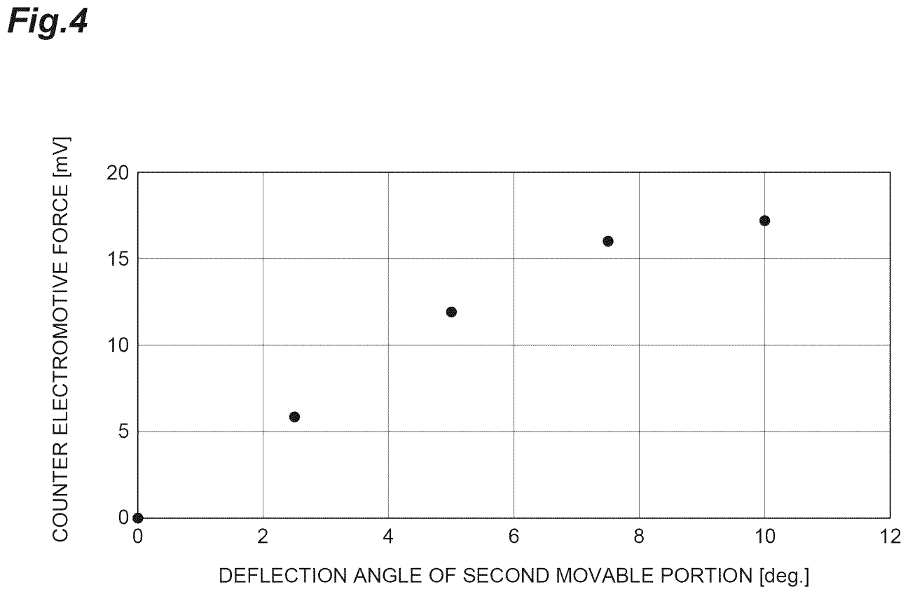

Here, the counter electromotive force caused by the driving of the first movable portion 3 and the counter electromotive force caused by the driving of the second movable portion 4 will be described in more detail with reference to FIGS. 3 and 4. FIG. 3 shows the counter electromotive force caused by the driving of the first movable portion 3 which is driven resonantly. Specifically, the relationship between the deflection angle of the first movable portion 3 and the counter electromotive force caused by the driving of the first movable portion 3 is shown when the deflection angle of the second movable portion 4 is 0°. The unit Vpp of the counter electromotive force caused by the driving of the first movable portion 3 represents the difference (potential difference) between the maximum value and the minimum value of the amplitude of the fluctuating counter electromotive force. FIG. 4 shows a counter electromotive force caused by the driving of the second movable portion 4 which is driven non-resonantly. Specifically, the relationship between the deflection angle of the second movable portion 4 and the counter electromotive force caused by the driving of the second movable portion 4 is shown when the second movable portion 4 is driven non-resonantly (swung continuously) at 60 Hz while the first movable portion 3 is driven resonantly at a deflection angle of 20°. The counter electromotive force shown in FIG. 4 is a value acquired by amplifying the counter electromotive force generated in the coil by 39 times. As shown in FIGS. 3 and 4, each of the counter electromotive force caused by the driving of the first movable portion 3 and the counter electromotive force caused by the driving of the second movable portion 4 increases as the deflection angle of the movable portion increases. That is, it can be confirmed that the counter electromotive force generated in each of the coils 7 and 8 reflects the tilted state (deflection angle) of both the first movable portion 3 and the second movable portion 4. Therefore, the determination unit 14 can determine whether the second movable portion 4 is tilted by monitoring the counter electromotive force generated in the coils 7 and 8.

As described with reference to FIG. 3, the counter electromotive force generated in each of the coils 7 and 8 reflects the tilted state of the first movable portion 3. Therefore, the controller 11 can perform feedback control of the tilted state of the first movable portion 3 by adjusting the first drive signal supplied in the supply step S1 on the basis of the counter electromotive force generated in the coils 7 and 8. For example, the controller 11 can maintain the resonance state of the first movable portion 3 by adjusting the phase difference between the counter electromotive force generated in the coils 7 and 8 and the supplied first drive signal to be maintained at 90°.

Subsequently, when it is determined that an abnormality has occurred in the tilted state of the second movable portion 4 in the determination step S3, the light source 50 stops irradiating the mirror surface 31a with the light L (stop step S4). On the other hand, when it is determined that no abnormality has occurred in the tilted state of the second movable portion 4 in the determination step S3, the light source 50 continues irradiating the mirror surface 31a with the light L. By performing the above-described abnormality detection method, when an abnormality has occurred in the actuator device 1, the abnormality can be detected.

### Functions and Effects

In the abnormality detection method of the actuator device 1 according to this embodiment, an output value corresponding to the counter electromotive force generated in the coils 7 and 8 is acquired when the second drive signal is being supplied to the coil 8 in the supply step S1 and it is determined whether an abnormality has occurred in the tilted state of the second movable portion 4 on the basis of the second drive signal supplied to the coil 8 in the supply step S1 and the output values (first output value and second output value) acquired in the acquisition step S2. For example, when the magnetic force received by the coils 7 and 8 changes due to demagnetization of the magnet portion 9 or positional deviation between the magnet portion 9 and the coils 7 and 8, the counter electromotive force generated in the coils 7 and 8 also changes. In the abnormality detection method according to this embodiment, since an abnormality in the tilted state of the second movable portion 4 is detected using the counter electromotive force generated in the coils 7 and 8, it is possible to detect an abnormality in the actuator device 1 caused by various factors such as demagnetization of the magnet portion 9 or positional deviation between the magnet portion 9 and the coils 7 and 8 in addition to the abnormality generated in the coil 8. Therefore, according to the abnormality detection method of this embodiment, it is possible to more reliably detect an abnormality in the actuator device 1.

The abnormality detection method according to this embodiment was developed on the basis of the following findings made by the present inventors. That is, when the second movable portion 4 is driven non-resonantly, the moving speed of the second movable portion 4 is slower than when the second movable portion 4 is driven resonantly, so that the counter electromagnetic force generated in the coils 7 and 8, which the coils are arranged in the second movable portion 4, due to the driving of the second movable portion 4 is relatively small. This is because the counter electromotive force increases according to the speed at which the coils 7 and 8 move within the magnetic field and the counter electromotive force increases since the moving speed is fast in the case of resonance driving. For example, as shown in FIGS. 3 and 4, the counter electromotive force (FIG. 4) caused by the driving of the second movable portion 4 that is driven non-resonantly is a value on the order of mV, and is smaller than the counter electromotive force (FIG. 3) caused by the driving of the first movable portion 3 that is driven resonantly. Therefore, when the change in the deflection angle of the second movable portion 4 is small (for example, 0.1°), the change in the counter electromotive force caused by the driving of the second movable portion 4 is also small. Therefore, when the second movable portion 4 is driven non-resonantly, it is considered that accurately monitoring the angle of the second movable portion 4 on the basis of the counter electromotive force generated in the coils 7 and 8 (to detect a slight positional deviation from the target deflection angle) is difficult. On the other hand, the present inventors have found that it is possible to determine whether an abnormality has occurred in the tilted state of the second movable portion 4 using a relatively small counter electromotive force although it is not possible to accurately monitor the angle of the second movable portion 4. Specifically, the present inventors have found that it is possible to determine, for example, whether the second movable portion 4 is tilted or to roughly determine the deflection angle of the second movable portion 4 using the counter electromotive force caused by the driving of the second movable portion 4. The rough determination of the deflection angle of the second movable portion 4 means, for example, determining the deflection angle at intervals of 1° or more. Examples of this rough determination include determining whether the deflection angle of the second movable portion 4 is any one of 0° and 12° (which one is closer to the deflection angle) or determining whether the deflection angle of the second movable portion 4 is any one of 0°, 5°, and 10° (which one is closer to the deflection angle). On the basis of the results of determination on whether the second movable portion 4 is tilted, rough determination of the deflection angle of the second movable portion 4, and the like, it is possible to determine whether an abnormality has occurred in the tilted state of the second movable portion 4. In other words, according to the abnormality detection method of this embodiment, it is possible to detect an abnormality which can be detected by monitoring the counter electromotive force generated in the coils 7 and 8 due to the driving of the second movable portion 4. Further, according to the abnormality detection method of this embodiment, it is possible to detect an abnormality relating to the tilted state of the second movable portion 4 without separately providing a function part (for example, a sensor such as a piezoelectric element or a strain gauge) that senses the deflection angle of the second movable portion 4, for example, in a device including an electromagnetic MEMS mirror used for two-dimensional raster scanning, such as the actuator device 1.

The controller 11 supplies a first drive signal and a second drive signal to the coils 7 and 8 in the supply step S1 and acquires a first output value and a second output value in the acquisition step S2 while the first drive signal and the second drive signal are supplied to the coils 7 and 8 in the supply step S1. Accordingly, it is possible to determine whether an abnormality has occurred in the tilted state of the second movable portion 4 while the first movable portion 3 is driven resonantly. Further, in the actuator device 1, the coil 7 for driving the first movable portion 3 is formed in the second movable portion 4. Thus, when the first drive signal is supplied to the coil 7 to resonantly drive the first movable portion 3, the second movable portion 4 also vibrates at a frequency corresponding to the resonance frequency of the first movable portion 3. Therefore, the counter electromotive force generated in the coils 7 and 8 arranged in the second movable portion 4 reflects the tilted state of the first movable portion 3. Therefore, the controller 11 can perform feedback control of the tilted state of the first movable portion 3 by adjusting the first drive signal supplied in the supply step S1 on the basis of the counter electromotive force generated in the coils 7 and 8. For example, the controller 11 can maintain the resonance state of the first movable portion 3 by adjusting the phase difference between the counter electromotive force generated in the coils 7 and 8 and the supplied first drive signal to be maintained at 90°.

In the determination step S3, it is determined whether an abnormality has occurred in the tilted state of the second movable portion 4 by determining whether the second movable portion 4 is tilted. Accordingly, it is possible to detect an abnormality in which the second movable portion 4, which should be tilted, is not tilted.

The drive portion that drives the first movable portion 3 and the second movable portion 4 includes the coil 7 for driving the first movable portion 3 and the coil 8 for driving the second movable portion 4 and the detection coil is composed of the coils 7 and 8. Accordingly, the space for arranging the coil in the second movable portion 4 can be reduced compared to a case in which the detection coil is provided separately from the drive coil.

The drive portion that drives the first movable portion 3 and the second movable portion 4 includes the coil 7 for driving the first movable portion 3 and the coil 8 for driving the second movable portion 4 and the coil 7 and the coil 8 are arranged in the second movable portion 4. As a result, the weight of the first movable portion 3 driven resonantly can be reduced and the power for driving the first movable portion 3 can be reduced compared to a case in which the coil 7 is disposed in the first movable portion 3. Moreover, the inertia moment of the first movable portion 3 around the X axis can be reduced, and a decrease in the resonance frequency can be suppressed.

The detection coil is composed of the coil 7 and the coil 8, acquires the first output value corresponding to the counter electromotive force generated in the coil 7 and the second output value corresponding to the counter electromotive force generated in the coil 8 while the second drive signal is supplied to the coil 8 in the acquisition step S2, and determines whether an abnormality has occurred in the tilted state of the second movable portion 4 on the basis of the second drive signal supplied to the coil 8 in the supply step S1 and the first output value and the second output value acquired in the acquisition step S2 in the determination step S3. Accordingly, it is possible to more reliably determine whether an abnormality has occurred in the tilted state of the second movable portion 4.

The drive portion for driving the first movable portion 3 and the second movable portion 4 includes the coil 7 (first drive portion) for driving the first movable portion 3 and the coil 8 (second drive portion) for driving the second movable portion 4 and the coils 7 and 8 are arranged in the second movable portion 4. As a result, since the coil 7 is disposed in the second movable portion 4, the second movable portion 4 is also vibrated at a frequency corresponding to the resonance frequency of the first movable portion 3 when the first drive signal is supplied to the coil 7 to resonantly drive the first movable portion 3. Therefore, the counter electromotive force generated in the coils 7 and 8 arranged in the second movable portion 4 reflects the tilted state of the first movable portion 3. That is, it is possible to acquire the output value of the counter electromotive force that reflects the tilted state of the first movable portion 3 in the acquisition step S2. Further, the counter electromotive force generated in the coils 7 and 8 arranged in the second movable portion 4 reflects the tilted state of both the first movable portion 3 and the second movable portion 4, and an output value of the counter electromotive force that reflects the tilted state of the first movable portion 3 and the second movable portion 4 can be acquired in the acquisition step S2. Moreover, the weight of the first movable portion 3 can be reduced and the inertia moment of the first movable portion 3 can be reduced compared to a case in which the coil 7 is disposed in the first movable portion 3.

In the supply step S1, the controller 11 supplies a signal for continuously swinging the second movable portion 4 at a target deflection angle (predetermined deflection angle) to the coil 8 as a second drive signal. Accordingly, it is possible to determine whether an abnormality has occurred in the tilted state of the second movable portion 4 when the second movable portion 4 is continuously swung at the target deflection angle.

The actuator device 1 includes the amplification circuit 13. In the acquisition step S2, the counter electromotive force generated in the coil 7, which has been amplified 10 times or more by the amplification circuit 13, is acquired as a first output value, and the counter electromotive force generated in the coil 8, which has been amplified 10 times or more by the amplification circuit 13, is acquired as a second output value. Accordingly, it is possible to satisfactorily determine whether an abnormality has occurred in the tilted state of the second movable portion 4 even when the change in the counter electromotive force generated in the coils 7 and 8 is small.

The actuator device 1 includes the mirror surface 31a which is formed in the first movable portion 3 and onto which the light L from the light source 50 is incident. Accordingly, it is possible to more reliably detect an abnormality in the actuator device 1 including the mirror surface 31a onto which the light L from the light source 50 is incident.

The abnormality detection method of the actuator device 1 according to this embodiment includes the stop step S4 of stopping irradiating the mirror surface 31a with the light L from the light source 50 when it is determined that an abnormality has occurred in the tilted state of the second movable portion 4 in the determination step S3. Accordingly, since the irradiation of the light L to the mirror surface 31a is stopped when it is determined that an abnormality has occurred in the tilted state of the second movable portion 4, it is possible to prevent, for example, a situation in which the light L reflected by the mirror surface 31a continuously irradiates an object to thereby damage the object.

### MODIFIED EXAMPLE

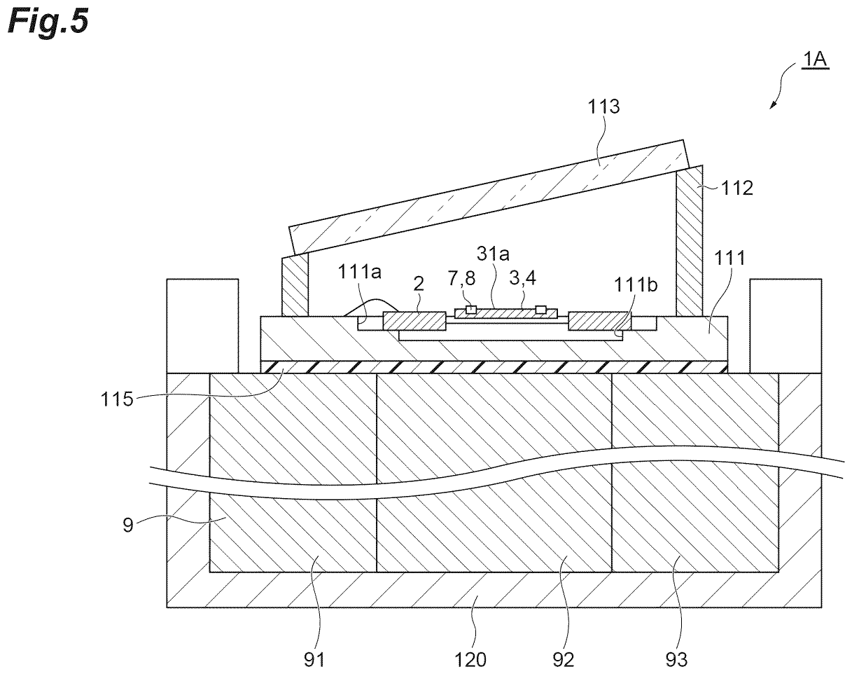

An actuator device 1A shown in FIG. 5 includes a base 111, a side wall 112, a window material 113, and a package 120 in addition to the support portion 2, the first movable portion 3, the second movable portion 4, the pair of first torsion bars 5, the pair of second torsion bars 6, the coils 7 and 8, and the magnet portion 9.

The base 111 is formed in, for example, a rectangular plate shape, and the support portion 2 is disposed on the base 111. More specifically, a recess 111a is formed in the base 111, and a recess 111b is formed in the bottom surface of the recess 111a. The support portion 2 is disposed on the bottom surface of the recess 111a, and the first movable portion 3 and the second movable portion 4 face the bottom surface of the recess 111b. The coils 7 and 8 are located inside the outer edge of the recess 111a when viewed from a direction perpendicular to the X axis and the Y axis. The coils 7 and 8 are located inside the outer edge of the recess 111b when viewed from a direction perpendicular to the X axis and the Y axis.

The side wall 112 is formed, for example, in a rectangular cylindrical shape. The window material 113 is formed in a rectangular plate shape by, for example, a translucent material, and is disposed on the side wall 112. The window material 113 is disposed to be inclined with respect to the mirror surface 31a when the deflection angle is 0°. Wiring is formed on the base 111, and the wiring is electrically connected to the coils 7 and 8 via wires.

By providing the base 111, it is possible to prevent damage to a relatively delicate chip having the first movable portion 3 and the second movable portion 4. From the viewpoint of stably supporting the chip and preventing damage, the thickness of the base 111 (thickness other than a position in which the recesses 111a and 111b are formed) is preferably larger than the thickness of the chip (thickness of the support portion 2). By increasing the thickness of the base 111, distortion of the base 111 due to changes in environmental temperature and the like can be suppressed.

The package 120 has a substantially rectangular parallelepiped outer shape and accommodates the magnet portion 9. The magnet portion 9 includes magnets 91, 92, and 93. The magnets 91 to 93 are arranged in a Halbach array and generate a magnetic field that acts on the coils 7 and 8. A base 111 is fixed on the magnet portion 9 with resin 115. The magnet portion 9 is located on one side (the opposite side to the mirror surface 31a) (the lower side in FIG. 5) in a direction perpendicular to the X axis and the Y axis with respect to the support portion 2, the first movable portion 3, the second movable portion 4, and the like. The magnet portion 9 is disposed to overlap the support portion 2, the first movable portion 3, the second movable portion 4, and the like in a direction perpendicular to the X axis and the Y axis. In this example, at least a part of the magnet 92 (center magnet) located at the center (located between the magnets 91 and 91) among the magnets 91, 92, and 93 included in the magnet portion 9 overlaps the support portion 2, the first movable portion 3, the second movable portion 4, and the like in a direction perpendicular to the X axis and the Y axis. Even in such an actuator device 1A, it is possible to more reliably detect an abnormality in the actuator device 1A by the above-described abnormality detection method. Additionally, the base 111 may not be provided and, for example, the chip (support portion 2) may be disposed on the magnet portion 9 via the resin 115. In this case, since the distance between the coils 7 and 8 and the magnet portion 9 becomes short, the signal amount of the counter electromotive force generated in the detection coil can be increased.

The present disclosure is not limited to the above-described embodiment and modified example. The material and shape of each configuration are not limited to the materials and shapes described above, but various materials and shapes can be adopted. For example, in the above-described embodiment, both the coil 7 and the coil 8 constitute the detection coil, but the detection coil may be composed of one of the coil 7 and the coil 8. When the detection coil is composed of the coil 7, the acquisition unit 12 acquires the first output value corresponding to the counter electromotive force generated in the coil 7, and the determination unit 14 determines whether an abnormality has occurred in the tilted state of the second movable portion 4 on the basis of the second drive signal supplied to the coil 8 in the supply step S1 and the acquired first output value. In this case, the acquisition unit 12 may not acquire the second output value corresponding to the counter electromotive force generated in the coil 8.

When the detection coil is composed of the coil 7 for resonantly driving the first movable portion 3, the counter electromotive force generated in the detection coil tends to increase compared to, for example, a case in which the detection coil is composed of the coil 8 for non-resonantly driving the second movable portion 4. When a large counter electromotive force can be acquired, the gain for amplifying the counter electromotive force to a certain value can be reduced, and the noise superimposed on the first output value corresponding to the counter electromotive force can be reduced. Specifically, as in the actuator device 1, generally, the number of turns of the coil 7 for resonantly driving the first movable portion 3 is larger than the number of turns of the coil 8 for non-resonantly driving the second movable portion 4. Since the detection coil is composed of the coil 7 with a large number of turns, a more larger counter electromotive force can be acquired compared to a case in which the detection coil is composed of the coil 8 with a relatively small number of turns and noise superimposed on the first output value can be reduced. That is, when the number of turns of the coil 7 is larger than the number of turns of the coil 8, the detection coil may be composed of the coil 7. In this case, the counter electromotive force generated in the detection coil can be increased, and noise superimposed on the output value corresponding to the counter electromotive force can be reduced. Furthermore, an increase in the size of the second movable portion 4 can be suppressed compared to, for example, a case in which the number of turns of both the coils 7 and 8 is large. Additionally, the number of turns of the coil 8 may be larger than the number of turns of the coil 7, and in this case, the detection coil may be composed of the coil 8. Further, the number of turns of the coils 7 and 8 may be the same.

When the detection coil is composed of the coil 8, the acquisition unit 12 acquires the second output value corresponding to the counter electromotive force generated in the coil 8, and the determination unit 14 determines whether an abnormality has occurred in the tilted state of the second movable portion 4 on the basis of the second drive signal supplied to the coil 8 in the supply step S1 and the acquired second output value. In this case, the acquisition unit 12 may not acquire the first output value corresponding to the counter electromotive force generated in the coil 7.

The coils 7 and 8 may not be arranged in the second movable portion 4. The coil 7 may be disposed in the first movable portion 3 (for example, the annular portion 32). The actuator device 1 may further include another coil disposed in the second movable portion 4 (for example, the arrangement region R) different from the coils 7 and 8, and the detection coil may be composed of the another coil. When the detection coil is composed of another coil, the acquisition unit 12 acquires an output value corresponding to the counter electromotive force generated in the other coil, and the determination unit 14 determines whether an abnormality has occurred in the tilted state of the second movable portion 4 on the basis of the second drive signal supplied to the coil 8 in the supply step S1 and the output value acquired by the acquisition unit 12.

One of the coils 7 and 8 may be omitted and the other coil may constitute a single drive coil for driving both the first movable portion 3 and the second movable portion 4. The single drive coil may be disposed in the second movable portion 4 (for example, the arrangement region R), and the detection coil may be composed of the single drive coil. In this case, the controller 11 may supply a signal in which the first drive signal and the second drive signal are superimposed on each other to the single drive coil in the supply step S1. The acquisition unit 12 acquires an output value corresponding to the counter electromotive force generated in the single drive coil in the acquisition step S2, and the determination unit 14 determines whether an abnormality has occurred in the tilted state of the second movable portion 4 on the basis of the second drive signal supplied to the single drive coil in the supply step S1 and the output value acquired in the acquisition step S2. In this case, the number of turns of the drive coil (single drive coil) for driving the first movable portion 3 and the second movable portion 4 can be increased compared to a case in which a drive coil for driving the first movable portion 3 and a drive coil for driving the second movable portion 4 are provided separately. Then, since the detection coil is composed of a single drive coil with a large number of turns, the signal amount of the counter electromotive force generated in the detection coil can be increased.

In the above-described embodiment, the actuator device 1 is configured to be electromagnetically driven, and the drive portion that drives the first movable portion 3 and the second movable portion 4 includes the coils 7 and 8. However, the actuator device 1 may be piezoelectrically or electrostatically driven. In the former case, the drive portion includes, for example, a piezoelectric element (for example, a piezoelectric film), and in the latter case, the drive portion includes, for example, a drive electrode (for example, a comb electrode) that generates an electrostatic force. The piezoelectric film may be disposed in the pair of second torsion bars 6. The second drive portion for driving the second movable portion 4 may be disposed in the second movable portion 4 as in the above-described embodiment or may be disposed in the second torsion bar 6 (second connection portion).

In the supply step S1, the controller 11 supplies the coil 8 with a signal for continuously swinging the second movable portion 4 at a predetermined deflection angle as a second drive signal, but the controller 11 may supply the coil 8 with a signal for stopping the second movable portion 4 at a predetermined angle as a second drive signal. In this case, in the acquisition step S2, the acquisition unit 12 may acquire the first output value and the second output value while the signal for stopping the second movable portion 4 at a predetermined angle is supplied to the coil 8 in the supply step S1. As a result, it is possible to determine whether an abnormality has occurred in the tilted state of the second movable portion 4 when stopping the second movable portion 4 at a predetermined angle (when allowing the second movable portion 4 to perform a static operation). Although it has been described that the counter electromotive force changes depending on the deflection angle of the second movable portion 4 when the second movable portion 4 is continuously swung with reference to FIG. 4, the counter electromotive force changes depending on the deflection angle of the second movable portion 4 even when the second movable portion 4 is driven statically (to become static at a predetermined deflection angle). The counter electromotive force when the second movable portion 4 is statically driven is smaller than the counter electromotive force when the second movable portion 4 is continuously swung. However, it is possible to determine whether an abnormality has occurred in the tilted state of the second movable portion 4 by monitoring the change.

In the supply step S1, the controller 11 may supply only the second drive signal to the coil 8 without supplying the first drive signal to the coil 7. In this case, in the acquisition step S2, the acquisition unit 12 may acquire the first output value and the second output value while the first drive signal is not supplied to the coil 7 in the supply step S1. That is, the acquisition unit 12 may acquire the first output value and the second output value while the first movable portion 3 is not driven resonantly.

In the above-described embodiment, the determination unit 14 determines whether an abnormality has occurred in the tilted state of the second movable portion 4 by determining whether the second movable portion 4 is tilted. However, the determination unit 14 may determine whether an abnormality has occurred in the tilted state of the second movable portion 4 without determining whether the second movable portion 4 is tilted. For example, the determination unit 14 may determine whether an abnormality has occurred in the tilted state of the second movable portion 4 by determining whether the actual deflection angle of the second movable portion 4 deviates from the target deflection angle instead of determining whether the second movable portion 4 is tilted. As described above, the counter electromotive force caused by the driving of the second movable portion 4 which is driven non-resonantly is smaller than the counter electromotive force caused by the driving of the first movable portion 3 which is driven resonantly, but the deflection angle of the second movable portion 4 can be roughly determined by using a relatively small counter electromotive force. As an example, when the determination unit 14 determines that the deflection angle of the second movable portion 4 is 5° instead of 10° even though the target deflection angle of the second movable portion 4 is 10°, it is determined that an abnormality has occurred in the tilted state of the second movable portion 4.

The actuator device 1 may not include the amplification circuit 13. In this case, in the acquisition step S2, the acquisition unit 12 may acquire the counter electromotive force generated in the coil 7 as it is as the first output value, and acquire the counter electromotive force generated in the coil 8 as it is as the second output value.

The actuator device 1 may be a device in which an optical function part other than the mirror surface 31a is formed in the first movable portion 3. The optical function part formed in the first movable portion 3 may be, for example, a diffraction grating or the like.

The stop step S4 may be omitted, and the abnormality detection method for the actuator device 1 may include a step of reducing the intensity of the light L emitted by the light source 50 or a step of notifying the occurrence of an abnormality by the actuator device 1 instead of the stop step S4. The step of notifying the occurrence of an abnormality by the actuator device 1 may be performed, for example, in such a manner that the determination unit 14 outputs a signal indicating the occurrence of an abnormality to an output device (such as a display or a speaker) and the output device notifying the occurrence of an abnormality (for example, by outputting the screen or audio) on the basis of the signal. In the above-described embodiment, the light source 50 has been described as a part of the configuration of the actuator device 1, but the light source 50 may be considered as a configuration different from that of the actuator device 1. The actuator device 1 may further include a light receiving unit, and the light L emitted from the light source 50 and reflected on the mirror surface 31a may be received by the light receiving unit. In this case, it is possible to more accurately detect the deflection angle of the second movable portion 4.

What is claimed is:

1. An abnormality detection method of detecting an abnormality in an actuator device,
the actuator device including:
a support portion;
a first movable portion,
a second movable portion disposed to surround the first movable portion,
a first connection portion connecting the first movable portion to the second movable portion so that the first movable portion is swingable around a first axis,
a second connection portion connecting the second movable portion to the support portion so that the second movable portion is swingable around a second axis intersecting the first axis,
a detection coil disposed in the second movable portion,
a magnet portion generating a magnetic field acting on the detection coil,
a drive portion driving the first movable portion and the second movable portion, and
a controller configured to supply a first drive signal for resonantly driving the first movable portion and a second drive signal for non-resonantly driving the second movable portion to the drive portion,
the abnormality detection method comprising:
a supply step of supplying the second drive signal to the drive portion by the controller;
an acquisition step of acquiring an output value corresponding to a counter electromotive force generated in the detection coil while the second drive signal is supplied to the drive portion in the supply step; and
a determination step of determining whether an abnormality has occurred in a tilted state of the second movable portion on the basis of the second drive signal supplied to the drive portion in the supply step and the output value acquired in the acquisition step.

2. The abnormality detection method according to claim 1,
wherein in the supply step, the controller supplies the first drive signal and the second drive signal to the drive portion, and
wherein in the acquisition step, the output value is acquired while the first drive signal and the second drive signal are supplied to the drive portion in the supply step.

3. The abnormality detection method according to claim 1,
wherein in the determination step, it is determined whether an abnormality has occurred in a tilted state of the second movable portion by determining whether the second movable portion is tilted.

4. The abnormality detection method according to claim 1,
wherein the drive portion includes a drive coil for driving at least one of the first movable portion and the second movable portion, and
wherein the detection coil is composed of the drive coil.

5. The abnormality detection method according to claim 1,
wherein the drive portion includes a first drive coil for driving the first movable portion and a second drive coil for driving the second movable portion, and
wherein the first drive coil and the second drive coil are arranged in the second movable portion.

6. The abnormality detection method according to claim 5,
wherein the detection coil is composed of the first drive coil and the second drive coil,
wherein in the acquisition step, a first output value corresponding to a counter electromotive force generated in the first drive coil and a second output value corresponding to a counter electromotive force generated in the second drive coil are acquired while the second drive signal is supplied to the drive portion, and
wherein in the determination step, it is determined whether an abnormality has occurred in a tilted state of the second movable portion on the basis of the second drive signal supplied to the drive portion in the supply step and the first output value and the second output value acquired in the acquisition step.

7. The abnormality detection method according to claim 5,
wherein the number of turns of one of the first drive coil and the second drive coil is larger than the number of turns of the other of the first drive coil and the second drive coil, and
wherein the detection coil is composed of the one of the first drive coil and the second drive coil.

8. The abnormality detection method according to claim 1,
wherein the drive portion includes a first drive portion for driving the first movable portion and a second drive portion for driving the second movable portion,
wherein the first drive portion is disposed in the second movable portion, and
wherein the second drive portion is disposed in the second movable portion or the second connection portion.

9. The abnormality detection method according to claim 1,
wherein the drive portion includes a single drive coil for driving both the first movable portion and the second movable portion,
wherein the single drive coil is disposed in the second movable portion, and
wherein the detection coil is composed of the single drive coil.

10. The abnormality detection method according to claim 1,
wherein in the supply step, the controller supplies a signal for continuously swinging the second movable portion at a predetermined deflection angle to the drive portion as the second drive signal.

11. The abnormality detection method according to claim 1,
wherein in the supply step, the controller supplies a signal for stopping the second movable portion at a predetermined angle to the drive portion as the second drive signal.

12. The abnormality detection method according to claim 1,
wherein the actuator device further includes an amplification circuit, and
wherein in the acquisition step, the counter electromotive force amplified 10 times or more by the amplification circuit is acquired as the output value.

13. The abnormality detection method according to claim 1,
wherein the actuator device further includes an optical function part which is formed in the first movable portion and onto which light is incident from a light source.

14. The abnormality detection method according to claim 13, further comprising:
a stop step of stopping irradiating the optical function part with light from the light source when it is determined that an abnormality has occurred in a tilted state of the second movable portion in the determination step.

15. An actuator device comprising:
a support portion;
a first movable portion;
a second movable portion disposed to surround the first movable portion;
a first connection portion connecting the first movable portion to the second movable portion so that the first movable portion is swingable around a first axis;
a second connection portion connecting the second movable portion to the support portion so that the second movable portion is swingable around a second axis intersecting the first axis;
a detection coil disposed in the second movable portion;
a magnet portion generating a magnetic field acting on the detection coil;
a drive portion driving the first movable portion and the second movable portion;
a controller configured to supply a first drive signal for resonantly driving the first movable portion and a second drive signal for non-resonantly driving the second movable portion to the drive portion;
an acquisition unit acquiring an output value corresponding to a counter electromotive force generated in the detection coil while the second drive signal is supplied from the controller to the drive portion; and
a determination unit determining whether an abnormality has occurred in a tilted state of the second movable portion on the basis of the second drive signal supplied to the drive portion during acquisition of the output value by the acquisition unit and the output value acquired by the acquisition unit.
